(19) United States
(12) Patent Application Publication
(10) Pub. No.: US 2025/0178011 A1
(43) Pub. Date: Jun. 5, 2025

(54) DEVICE FOR DISPENSING A FLUID SUBSTANCE

(71) Applicant: Coster Tecnologie Speciali S.p.A., CALCERANICA AL LAGO (TN) (IT)

(72) Inventors: Alfeo Tecchiolli, Meano (TN) (IT); Giancarlo Fontanari, ALTOPIANO DELLA VIGOLANA (TN) (IT); Fabiano Zeni, Mezzano (TN) (IT)

(21) Appl. No.: 18/970,392

(22) Filed: Dec. 5, 2024

(30) Foreign Application Priority Data
Dec. 5, 2023 (IT) 102023000025929

(51) Int. Cl. B05B 12/08

(52) U.S. Cl. CPC B05B 12/088

(57) ABSTRACT

A device for dispensing a fluid substance includes a cup-shaped body inside which a piston slides in a sealed manner counter to an elastic element featuring a hollow stem, there being a first valve element envisaged on the bottom of the cup-shaped body, the hollow stem being sealed to a dispensing button, the dispensing button featuring a nozzle and a second valve element, and a compression chamber determined at least partially by the cavity in the hollow stem, by at least part of the cup-shaped body, by at least part of the piston, by at least part of the dispensing button, and by the first and second valve elements, the nozzle being positioned between the second valve element and the first valve element.

This application claims priority to Italian Patent Application for Invention No. 102023000025929 filed on Dec. 5, 2023, the disclosure of which is hereby incorporated by reference.

### FIELD OF THE INVENTION

The present invention relates to a fluid substance dispensing device.

In particular, it refers to an environmentally compatible dispensing device designed to dispense a fluid cosmetic or medical substance, a perfume, a cream, etc.

### STATE OF THE ART

Commonly known dispensing devices for fluid substances envisage a pump which is operated manually by the end user.

They are normally constituted of many parts which are assembled together, therefore they are expensive.

Furthermore, commonly known dispensing devices make extensive use of metal components, which are difficult to recycle.

### SUMMARY OF THE INVENTION

The object of the present invention is to make a fluid substance dispensing device which is improved compared with the prior art.

A further object of the present invention is to provide a device for dispensing a fluid substance which is simpler and less costly than commonly known devices.

A still further object of the present invention is to provide a device for dispensing a fluid substance which is more environmentally compatible than commonly known devices.

This and other objects are achieved by means of a fluid substance dispensing device produced according to the technical teachings of the appended claims.

### BRIEF DESCRIPTION OF THE FIGURES

Further features and advantages of the innovation will become clearer in the description of a preferred but not exclusive embodiment of the device for dispensing a fluid substance, according to the present invention illustrated—by way of a non-limiting example—in the drawings annexed hereto, in which:

FIG. 1 is an axial sectional view of the device according to the present invention with a cap and in the upper stroke-limit position;

FIG. 2 is the same sectional view as FIG. 1, without the cap;

FIG. 3 is the sectional view shown in FIG. 2 taken in a lower stroke-limit position;

FIG. 4 is an enlarged view of the detail shown in the circle in FIG. 2;

FIG. 5 is a sectional view taken along line V-V in FIG. 2;

FIG. 6 is the sectional view taken along line VI-VI in FIG. 3;

FIG. 7 is an enlarged view of the detail shown in the circle in FIG. 6; and

FIG. 8 is a perspective view of a internal element of the device according to the present invention.

### DETAILED DESCRIPTION OF THE INVENTION

With reference to the figures stated, reference number 1 is used to denote, as a whole, a fluid substance dispensing device.

In this text, the term ‘fluid substance’ means a substance used in the cosmetic field, such as a perfume, a cream, or in the medical field, or a household cleaning substance, an air freshener, or the like.

The device 1 comprises a cup-shaped body 2 inside which a piston 3 slides in a sealed manner, counter to an elastic element 10.

A hollow stem 4, preferably made as a single piece with the piston 3, extends from the piston 3.

On the bottom of the cup-shaped body there is a first valve element 6 envisaged.

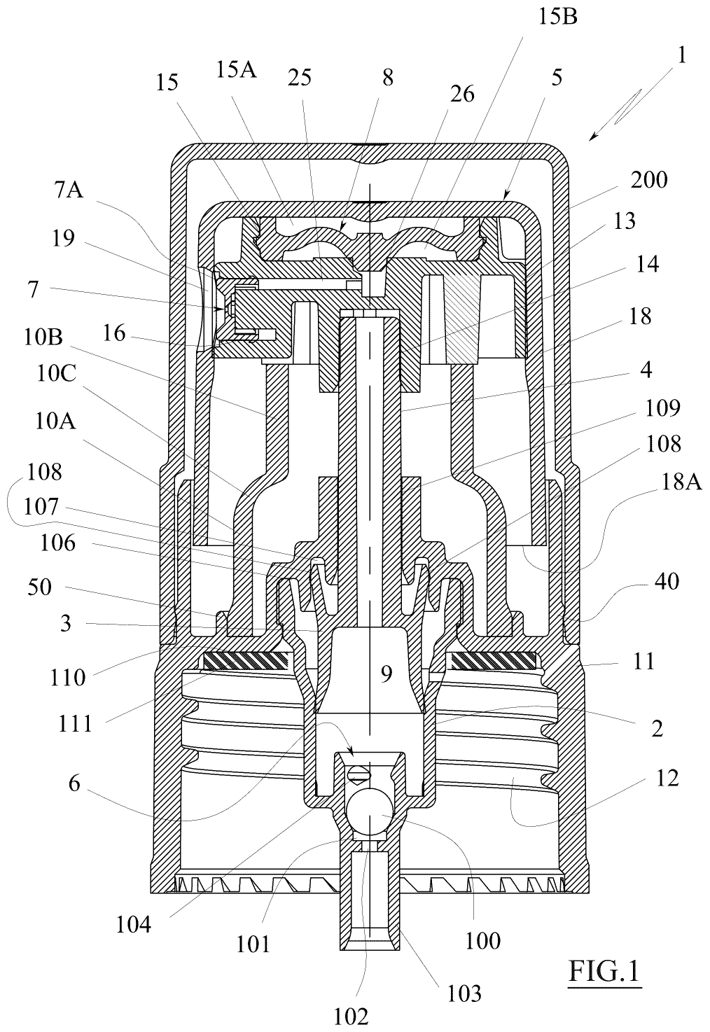

The first valve element 6 may be a ball 100, preferably made of a plastic material. In this case, on the bottom of the cup-shaped body there can be a suitable seat 101 made, into which the ball 100 can be snap-fitted (by means of teeth 104), which is freely movable in a limited upwards direction (in FIG. 1) in order to open a passage 102 and downwards to close the said passage.

The passage 102 can connect the outside of the cup-shaped body with the inside thereof.

Specifically, the cup-shaped body 2 can feature, at the passage 102, a projection 103 which is useful for the connection of an (optional) suction tube.

The cup-shaped body 2 can be snap-fitted (for example at an end thereof opposite the end where the first valve element 6 is positioned) onto an intermediate element 11.

The intermediate element 11 can feature a notched portion where a first groove 106 is made which houses the said end of the cup-shaped body 2 by snap-fit.

Internally, in a radial direction with respect to the first groove 106, there can be a second groove 107 made, which seals the piston 3 when the latter is in (or near) the upper stroke-limit position, as in FIG. 1. In this case, an upper lip 108 of the piston can form a seal against a wall in the second groove 107.

Also internally, in a radial direction with respect to the second groove, there can be a hole 109 made for the passage of the stem 4. Preferably, there is no seal between the stem and the hole.

In addition to that described so far, the intermediate element 11 may feature a thread 12 configured to couple the dispensing device 1 to a container (not shown) for the said fluid substance.

It is therefore possible that the intermediate element determines a flat surface 110 coupled with a sealing gasket 111, configured to form a seal against the container (not shown) when coupled to the thread 12.

Obviously, in place of the thread 12, other known coupling means can be envisaged between the intermediate element 11 and the container.

The hollow stem 4 is sealedly coupled to a dispensing button 5, preferably formed in several parts that will be described later.

The dispensing button 5 features or determines a nozzle 7. In the dispensing button 5 there is a second valve element 8 incorporated.

The device therefore features a compression chamber 9 determined at least partially by the cavity 4A in the hollow stem 4, by at least part of the cup-shaped body 2, by at least part of the piston 3, and by the first and second valve elements 6 and 8.

Optionally, the compression chamber is also determined by at least a part of the dispensing button 5.

The nozzle 7 is positioned between the second valve element 8 and the first valve element 6.

The elastic element 10 is positioned between the dispensing button 5 and the intermediate element 11.

The elastic element 10 may be a hollow tubular body made from a single piece of elastic material.

For example, the elastic material can be a thermoplastic elastomeric or polyolefin material (TPO, TPE, SEBS, COPA, TPV, TPV).

The Shore A hardness can be between 40 and 85.

The elastic modulus can be comprised between 1 and 120 Mpa.

The elongation percentage can be greater than 300.

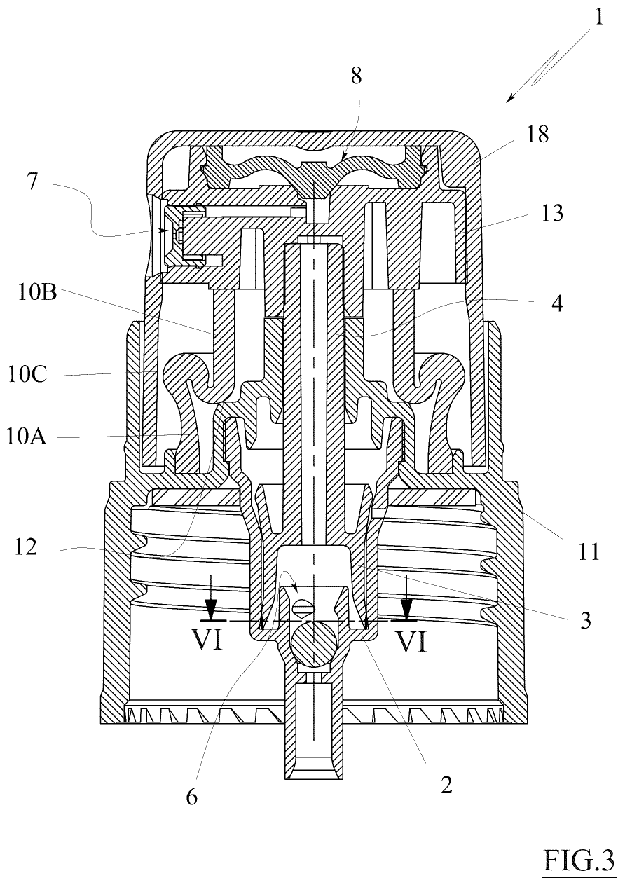

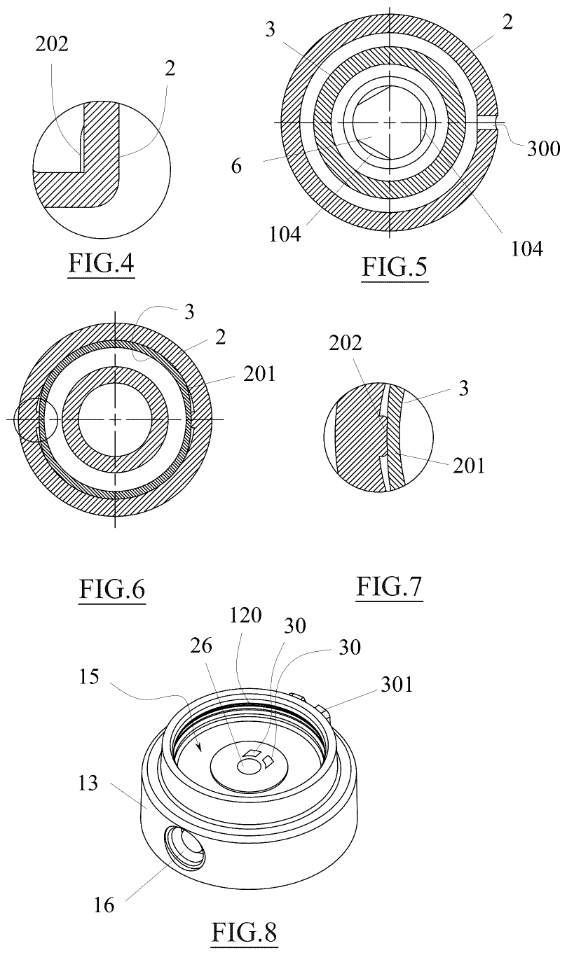

The elastic element can feature a first tubular section 10A connected to a second tubular section 10B with a smaller diameter than the first tubular section 10A, the first tubular section being connected to the second tubular section by a convex wall 10C so that when the elastic element 10 is compressed essentially at the stroke limit thereof (FIG. 3), the second tubular section 10B penetrates the first tubular section 10A.

Advantageously, when the elastic element 10 is compressed essentially at the stroke limi thereof (see FIG. 3), at least part 12 of the second tubular section 10B can come into contact with or be very close to the intermediate element 11.

The intermediate element 11 may feature, made as a single piece, a shoulder 50 (FIG. 1) which locks a free end of the elastic element 10 by interference fit.

For example, the elastic element 10 may have a thicker area at exactly the part which comes into contact with the shoulder 50.

As mentioned above, the dispenser button may be made of several pieces.

More specifically, the dispensing button 5 may comprise an internal element 13 (see FIG. 1) endowed with a cavity 14 for coupling with the hollow stem 4, a first seat 15 (see FIG. 8) for snap-fit (or undercut fit) housing the second valve element 8, and a second seat 16 for housing an insert 7A in the said nozzle 7.

The internal element 13 may be coupled, for example by snap-fit or by simple interference, to a casing 18 endowed with an opening 19 facing the said nozzle 7 or the said seat 16 which allows dispensing of the fluid substance.

The second valve element 8 can be housed in a cavity 15A determined by the said first seat 15 and by at least part of the casing 18.

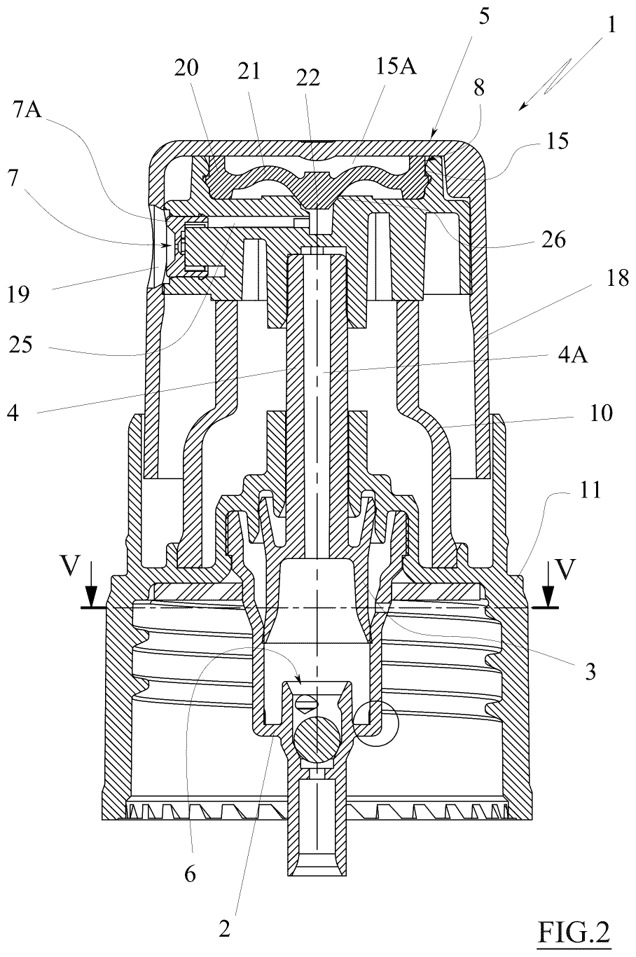

Advantageously, the second valve element 8 (FIG. 2) is discoidal, of the membrane kind, and has an external annular portion 20 that snap-fits or locks by undercut engagement with a wall 120 (FIG. 8) that determines the said first seat 15, a convex flexible wall 21, and an axial plug 22 connected to the convex flexible wall, the plug 22 intercepting a first fluid passage 25 endowed with an axial access 26 (clearly visible in FIG. 8) to the cavity 15B where the second valve element 8 is housed.

The second valve element 8 may have a fixed part (i.e. the external annular portion 20 connected to the dispensing button, and a movable part (i.e. the plug 22) intercepting the axial access 26) of the first passage 25.

The first fluid passage 25 can be fluidically connected to the nozzle 7, as visible in FIG. 1.

The first fluid passage 25 is preferably formed within the dispensing button 5, in the same piece.

The first fluid passage 25 is preferably located downstream to the second valve element 8, and collects the fluid leaving the second valve element 8.

Returning to FIG. 8, it should be noted that the internal element 13 can feature at least one second passage 30, preferably two second passages 30, which put the cavity 15B in communication with the cavity 4A of the stem 4 when the stem is coupled to the internal element 13; the second passage(s) 30 can be obtained laterally (along a more external circumference) with respect to the axial access 26.

Furthermore, the internal element 13 can feature protrusions 301 which are functional to the orientation of the casing 18. These can determine a cavity within which a special rib present in the internal part of the casing 18 is inserted so that the lateral hole of the casing 18 is perfectly aligned with the nozzle 7 and with the insert 7A.

Returning to the description of the intermediate element 11, it should be noted that the said element can feature a cylindrical wall 40, made as a single piece, whose internal diameter is slightly greater than the external diameter of the said casing 18 so that the cylindrical wall 40 conceals a free edge of the said casing 18 when at least part of the casing 18 is inserted telescopically into the cylindrical wall 40 during the full stroke of the dispenser.

It should be noted that the cylindrical wall 40 can also feature a system for fastening a removable cap 200 for the device. Specifically, the cap can be slid onto the cylindrical wall 40, and snap-fitted to it.

The operation of the invention is clear to a person skilled in the art and is essentially as follows.

Upon first operation of the device (which is mounted on a container containing the said fluid substance, together with a suction tube), the piston 3 is brought to the stroke limit as shown in FIG. 3. In this condition a lower sealing lip 201 of the piston deforms slightly (as visible in FIGS. 6 and 7) coming into contact with a relief 202 present on the bottom of the cup-shaped body 2.

The air present in the compression chamber then vents from the said compression chamber and as the piston rises, the chamber draws back the fluid substance, suctioned through the first valve element 6.

When the dispenser has been operated a few times, the compression chamber is essentially full of the fluid substance, which—upon subsequent operation—is pushed under pressure through the cavity 4A in the stem and reaches, via the passages 30, the seat 15 of the second valve element 8, or rather the cavity 15B there-below.

The pressure of the fluid substance raises the valve element by bending the flexible convex part 21 of the valve element, thereby lifting the plug 22, which opens the axial access 26 in communication with the passage 25 and therefore the nozzle 7.

The fluid substance is then dispensed from the said nozzle 7, possibly nebulised by the insert 7A (if present).

To balance the vacuum generated inside the container following the dispensing of the fluid substance, the cup-shaped body features a hole 300 (FIG. 5) that puts the interior of the container in communication with the external environment when the piston 3 is in an intermediate stroke position (therefore with the upper lip 108 disengaged from the second groove 107).

It has been seen how the configuration of the device 1 described endows extreme compactness despite featuring a (non-metallic) elastic element 10 devoid of contact with the fluid substance to be dispensed.

The compactness of the device is improved by the positioning of the nozzle 7 between the first valve element 6 and the second valve element 8, with a consequent considerable volume of the compression chamber that also extends to the cavity 4A in the stem 4 and part of the first seat 15 (cavity 15B), in which the second valve element 8 is positioned.

Furthermore, the device is made with a limited number of pieces, all of which can be easily and quickly assembled together.

The presence of a second valve element 8 with a large diameter (with an overall diameter of preferably between 20 mm and 10 mm, even more preferably between 16 mm and 14 mm) enables the construction of a waved section (as shown in the Figure) that is effective for a good spring effect.

With respect to conventional “lip systems”, this allows:
immediate opening at the desired pressure, without depending on a sliding movement;
the prevention of problems caused by possible elastic hysteresis of the lip;
unfortunately, few materials are suitable/functional for the production of lip systems, and the rigidity of such materials must be less than that of the dispenser material;
simplification of the pumping mechanism.

To end the description, it must be emphasised that the ball 102 in the first valve element 6 may be made of POLYPROPYLENE, HDPE, or PET.

The second valve element 8 is preferably made of POLYPROPYLENE, HDPE, LDPE, LLDPE, TPO, TPE, SEBS, TPV, or COPA.

The stem 4, preferably made as a single piece also featuring the piston 3, is advantageously made of POLYPROPYLENE, HDPE, LDPE, or LLDPE.

The other parts of the device may be made of the following materials:
cap 200: POLYPROPYLENE, PS, or SBS
intermediate element 11: POLYPROPYLENE or HDPE
internal element 13: POLYPROPYLENE or HDPE
casing 18: POLYPROPYLENE or HDPE

Various embodiments of the innovation have been disclosed herein, but further embodiments may also be conceived using the same innovative concept.

1. A dispensing device (1) of a fluid substance, comprising a cup-shaped body (2) within which a piston (3), preferably made in one piece with a hollow stem (4), slides sealedly in contrast to an elastic element (10), at the bottom of the cup-shaped body a first valve element (6) being provided, the hollow stem (4) being sealedly coupled to a dispensing button (5), the dispensing button (5) being provided with a nozzle (7) and a second valve element (8), a compression chamber (9) being defined at least partially by the cavity (4A) of the hollow stem (4), by at least part of the cup-shaped body (2) by at least part of the piston (3), by at least part of the dispensing button (5), and by the first and second valve elements (6, 8), the nozzle (7) being positioned between the second valve element (8) and the first valve element (6).

2. The device according to claim 1, wherein the elastic element (10) is positioned between the dispensing button (5) and an intermediate element (11) snap-coupled to the cup-shaped body (2) and provided with a thread (12) configured to couple the dispensing device (1) to a container of said fluid substance.

3. The device according to claim 1, wherein the elastic element (10) is a hollow tubular body made of a single piece of elastic material.

4. The device according to claim 1, wherein the elastic element (10) is a hollow tubular body made of a single piece of elastic material comprising a thermoplastic elastomeric or polyolefin material, having a shore A hardness between 40 and 85, an elastic modulus from 1 to 120 MPa, and a percent elongation greater than 300.

5. The device according to claim 1, wherein the elastic element (10) has a first tubular section (10A) connected to a second tubular section (10B) having a smaller diameter than the first tubular section (10A), the first tubular section being connected to the second tubular section by a curved wall (10C) so that when the elastic element (10) is compressed substantially to its end of the stroke, the second tubular section (10B) penetrates the first tubular section (10A).

6. The device according to claim 1, wherein, when the elastic element is compressed substantially to its end-stroke, at least a portion (12) of the second tubular section (10B) rests against the intermediate element (11), that acts as an end-stroke.

7. The device according to claim 1, wherein the dispenser button (5) comprises an inner element (13) having a coupling cavity (14) with the hollow stem (4), a first seat (15) housing the second valve element (8) and a second seat (16) housing an insert (7A) of said nozzle (7), the inner element (13) being snap-coupled to a casing (18) provided with an opening (19) facing said nozzle (7).

8. The device according to claim 6, wherein the second valve element (8) is housed in a cavity (15A) defined by said seat (15) and at least part of the casing (18).

9. The device according to claim 1, wherein the second valve element (8) is discoidal, of the membrane type, and comprises an annular portion (20) that is peripherically fitted to a wall defining said first seat (15), a convex flexible wall (21) and an axial plug (22) connected to the convex flexible wall, the plug intercepting a first fluid passage (25) equipped with an axial access (26) to the cavity (15A) where the second valve element (8) is housed, the first fluid passage being fluidically connected to the nozzle (7).

10. The device according to claim 1, wherein the inner element (13) provides at least one second passage (30), which connect the first seat (15) with the cavity (14) of the stem (4) when the stem is coupled to the inner element (13), the at least one second passage (30) being laterally positioned relative to the axial access (26).

11. The device according to claim 1 wherein the intermediate element (11) has, made in one piece, a cylindrical wall (40), the inner diameter of the cylindrical wall (40) being slightly larger than the outer diameter of said casing (18) so that the cylindrical wall (40) hides from view a free edge of said casing (18) when at least part of the lining is telescopically shod within the cylindrical wall (40), during the entire stroke of the button.

12. The device according to claim 1, in which the intermediate element (11) has, made in one piece, a shoulder (50) that blocks with interference a free end of the elastic element (10).
